(19) United States
(12) Patent Application Publication
(10) Pub. No.: US 2005/0170858 A1
(43) Pub. Date: Aug. 4, 2005

(54) WIRELESS COMMUNICATION SYSTEM UTILIZING DIELECTRIC MATERIAL TO ADJUST THE WORKING FREQUENCY OF AN ANTENNA

(76) Inventor: Wen-Suz Tao, Taipei Hsien (TW)

Correspondence Address: NORTH AMERICA INTERNATIONAL PATENT OFFICE (NAIPC), P.O. BOX 506, MERRIFIELD, VA, 22116, US

(21) Appl. No.: 10/709,713

(22) Filed: May 24, 2004

(30) Foreign Application Priority Data
Feb. 2, 2004 (TW) 093102333

(51) Int. Cl. H04M 1/00

(52) U.S. Cl. 455/550.1; 455/575.1

(57) ABSTRACT

A wireless communication system includes a housing and an antenna installed inside the housing. The antenna includes a radiator for transmitting and receiving radio signals, and a ground terminal connected to the radiator for grounding. The wireless communication system further includes a dielectric material installed inside the housing and not installed between the radiator and the ground terminal.

### BACKGROUND OF INVENTION

1. Field of the Invention

The present invention relates to a wireless communication system and more particularly, to a wireless communication system for adjusting antenna frequency impedance matching with a dielectric material.

2. Description of the Prior Art

In modern information-oriented society, it is desirable that information is accessible at anytime and at anyplace. Wireless communication equipment is capable of transmitting signals without the use of cables or optical fibers, making wireless communication arguably the best way to transmit information. As technology develops, various kinds of wireless communication devices, such as mobile phones and personal digital assistants (PDAs), have become come an important means of communicating due to their compactness and portability. In the field of wireless communication equipment, antennas, which are used to transmit and receive radio waves in order to transfer and exchange data signals, are unquestionably one of the most important devices. Especially in modern portable wireless communication devices, antennas are required to be compact and must be designed to occupy less space in order to match pace with the miniaturization trend of portable wireless devices.

Please refer to FIG. 1. FIG. 1 is a schematic diagram of a planar inverted F antenna (PIFA) 10 according to the prior art. The antenna 10 includes a radiator 12 for receiving and transmitting radio frequency (RF) signals, a feeding terminal 14 connected to a cable 15 for transmitting RF signals with an RF circuit (not shown in FIG. 1 ), and a ground terminal 16 positioned beneath the radiator 12 in parallel for grounding. The antenna 10 transmits and receives RF signals through the resonance of the radiator 12. The length of the radiator 12 determines the operation frequency for transmitting and receiving RF signals. The transmission of RF signals between the antenna 10 and the RF circuit depends on the connection between the feeding terminal 14 of the antenna 10 and the cable 15.

However, the operation frequency or performance of the antenna 10 varies due to a mechanical environment around the antenna 10. For example, antennas with the same structure but installed inside different types of notebooks have different performance values, such as a voltage standing wave ratio (VSWR), due to different spatial arrangements. To avoid decreasing the performance of antenna, antennas have to be designed according to the types of notebooks the antennas are to be used in. Depending on the notebook used, a corresponding antenna is chosen, or the length of the radiator 12 is adjusted. However, customizing the antennas in this way strays from the trends of modularization and standardization for reducing the cost of antennas.

### SUMMARY OF INVENTION

It is therefore a primary objective of the claimed invention to provide a wireless communication system for adjusting antenna frequency impedance matching with a dielectric material for solving the above-mentioned problem.

According the claimed invention, a wireless communication system includes a housing and an antenna installed inside the housing. The antenna includes a radiator for transmitting and receiving radio signals, and a ground terminal connected to the radiator for grounding. The wireless communication system further includes a dielectric material installed inside the housing and not installed between the radiator and the ground terminal.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of a planar inverted F antenna (PIFA) according to the prior art.

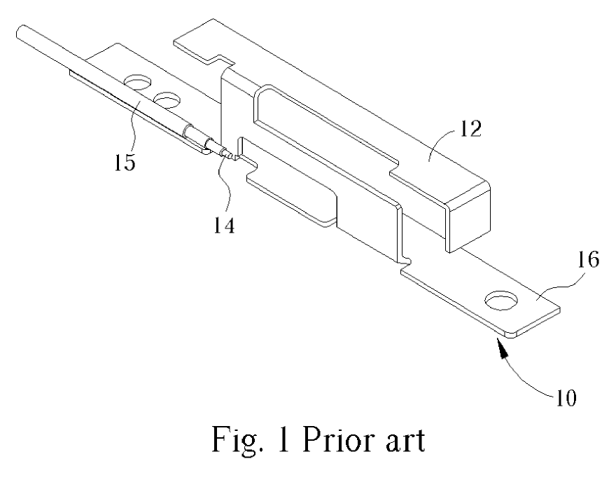

FIG. 2 is a functional block diagram of a wireless communication system according to the present invention.

FIG. 3 is a front view illustrating an antenna installed inside the wireless communication system according to the present invention.

FIG. 4 is a side view illustrating the antenna installed inside the wireless communication system according to the present invention.

FIG. 5 is a schematic diagram of a dielectric material positioned around the antenna.

### DETAILED DESCRIPTION

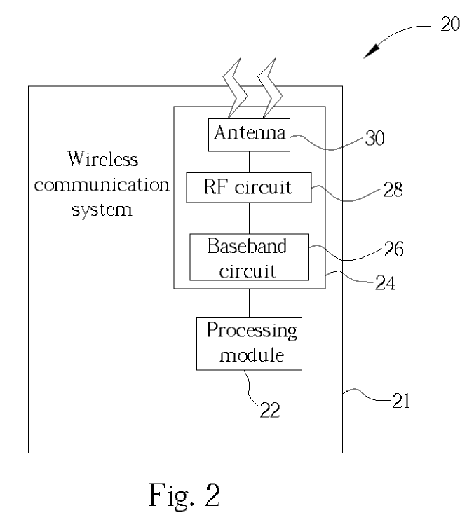

Please refer to FIG. 2. FIG. 2 is a functional block diagram of a wireless communication system 20 according to the present invention. The wireless communication system 20 can be a mobile phone, an access point, a PDA with wireless communication function, or a notebook computer. The wireless communication system includes a housing 21, a processing module 22 installed inside the housing 21 for controlling the wireless communication system 20, and a wireless communication module 24 installed inside the housing 21, which includes a baseband circuit 26, an RF circuit 28, and an antenna 30. The processing module 22 can transmit the communication signals to the baseband circuit 26. The baseband circuit 26 can encode the communication signals from the processing module 22 into baseband signals, then transmit them to the RF circuit 28. The RF circuit 28 modulates the baseband signals into RF signals and transmits them through the antenna 30. The RF circuit 28 can also receive RF signals through the antenna 30 and demodulate them into baseband signals. The baseband circuit 26 then decodes the baseband signals into communication signals and transmits them to the processing module 22. The RF signals transmitted by the antenna 30 can correspond with IEEE 802.11a, IEEE 802.11b, or IEEE 802.11g communication protocols.

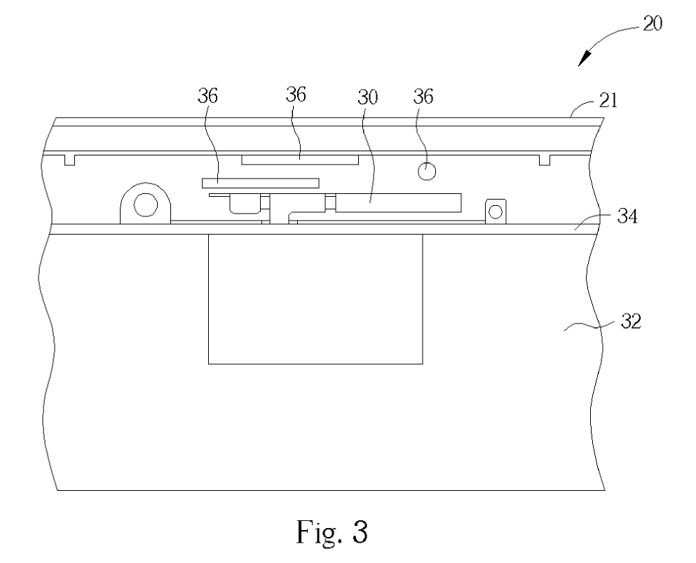

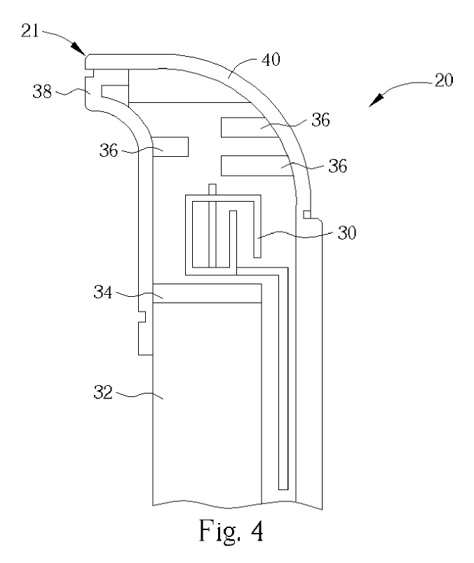

Please refer to FIG. 3 and FIG. 4. FIG. 3 is a front view illustrating the antenna 30 installed inside the wireless communication system 20 according to the present invention. FIG. 4 is a side view illustrating the antenna 30 installed inside the wireless communication system 20 according to the present invention. As shown in FIG. 3, the wireless communication system 20 is a notebook with a wireless communication function. The wireless communication system 20 further includes a LCD panel 32 for displaying data processed by the wireless communication system 20, and a bracket 34 installed above the LCD panel 32. The antenna 30 is positioned inside the housing 21 and above the bracket 34. Dielectric material 36 is installed inside the housing 21 and positioned around the antenna 30. The dielectric material 36 can be glued to the inner side of the housing 21, locked to the inner side of the housing 21, embedded in the inner side of the housing 21, or connected to the inner side of the housing 21 in a unionforming structure. The dielectric material 36 can be made of plastic, cermet, or a glass fiber substrate. That is, the dielectric material 36 can be made of any material at some dielectric constant. The shape of the dielectric material 36 can be a cube, a cylinder, or any other suitable shape. As shown in FIG. 4, the housing 21 includes a bezel 38 and a LCD cover 40. The bezel 38 and the LCD cover 40 can cover the LCD panel 32 in union for protecting the LCD panel from dust. The dielectric material 36 can be connected to the inner side of the bezel 38 and can be connected to the inner side of the LCD cover 40. The bracket 34 supports the antenna 30, and the antenna 30 is positioned between the bezel 38 and the LCD cover 40.

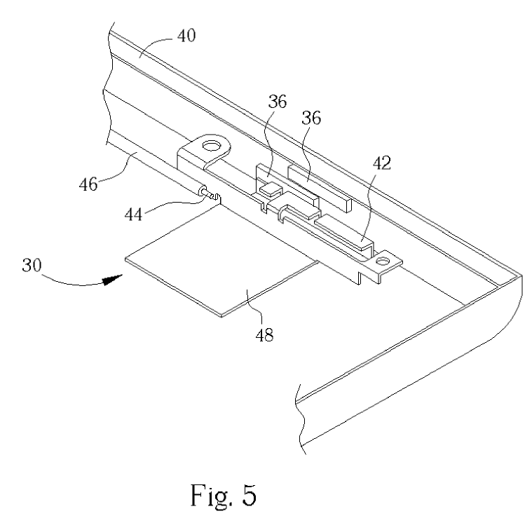

Please refer to FIG. 5. FIG. 5 is a schematic diagram of the dielectric material 36 positioned around the antenna 30. The antenna 30 can be a planar inverted-F antenna (PIFA). The antenna 30 includes a radiator 42 for receiving and transmitting RF signals, a feeding terminal 44 connected to a cable 46 for transmitting RF signals with the RF circuit 28 (not shown in FIG. 5 ), and a ground terminal 48 positioned beneath the radiator 42 for grounding. The antenna 30 transmits and receives RF signals through the resonance of the radiator 42. The length of the radiator 42 determines the operation frequency for transmitting and receiving RF signals. The transmission of RF signals between the antenna 30 and the RF circuit 28 depends on the connection between the feeding terminal 44 of the antenna 30 and the cable 46. The dielectric material 36 is positioned around the antenna 30 but is not positioned between the radiator 42 of the antenna 30 and the ground terminal 48 for preventing from reducing signal transmission quality of the antenna 30. The antenna frequency impedance matching can be adjusted by the surrounding dielectric material 36. That is, the dielectric material 36 positioned around the antenna 30 can increase the dielectric coefficient of the whole antenna 30 system, and the increasing dielectric coefficient depends on the material characteristics, the shape, the size, and the location of the dielectric material 36. Basically, when the size of the dielectric material 36 increases, the total equivalent dielectric coefficient increases. When the position of the dielectric material 36 gets close to the antenna 30, the total equivalent dielectric coefficient also increases. When the total equivalent dielectric coefficient increases, the operation frequency of the antenna 30 reduces due to the relation (C=

$$\frac{1}{\sqrt{μ ɛ}}$$

C: velocity of radio waves;
μ
   :permeability value;
E
   :dielectric coefficient). When the dielectric coefficient increases, the velocity of radio waves reduces. And because the velocity of radio waves is the product of the transmission frequency of radio waves and the wavelength of radio waves, the transmission frequency of radio waves will reduce too. That is, the operation frequency of the antenna 30 can be reduced by positioning the dielectric material 36 around the antenna 30.

The dielectric material 36 positioned around the antenna 30 can make the antennas in different mechanical environments have the same frequency impedance matching. For example, antennas with the same structure but installed inside different types of notebooks have different performance, such as voltage standing wave ratios (VSWR), due to different spatial arrangements. In certain mechanical environments an antenna can have the best performance because the operation frequency of the antenna matches the frequency of radio waves of transmission. But in other mechanical environments the antenna cannot have the best performance. That is, the VSWR of the operation frequency exceeds the standard value in these situations. At this time the dielectric material 36 can be positioned around the antenna to lower the frequency of radio waves of transmission so that the operation frequency of the antenna can match the lower frequency of radio waves of transmission because the VSWR of the operation frequency is under the standard value in this situation. Therefore, there is no need to apply different antennas on different computers so that the antenna design cost can be reduced.

Basically the reduction in the frequency of radio waves of transmission depends on the material characteristics, the shape, the size, and the location of the dielectric material 36. When the total dielectric coefficient increases, the frequency of radio waves of transmission reduces and the operation frequency of the antenna is also reduced. In addition, the radio waves can penetrate through the dielectric material 36, such as plastic, so the antenna gain cannot be influenced very much. Therefore, the present invention can achieve the goal of having antennas with the same structure, but installed inside different mechanical environments, all having matched frequency impedances, with the antenna gain not being influenced very much.

In contrast to the prior art, the wireless communication system according to the present invention can adjust antenna frequency impedance matching with dielectric materials positioned around the antenna. Therefore the same antenna can be applied in different mechanical environments by adjusting the material characteristics, the shape, the size, and the location of the dielectric material. Hence the present invention conforms to the trend of modularization and standardization, for reducing the cost of antennas.

Those skilled in the art will readily observe that numerous modifications and alterations of the device may be made while retaining the teachings of the invention. Accordingly, the above disclosure should be construed as limited only by the metes and bounds of the appended claims.

1. A wireless communication system comprising:
a housing;
an antenna installed inside the housing comprising:
a radiator for transmitting and receiving radio signals; and
a ground terminal connected to the radiator for grounding; and
a dielectric material installed inside the housing and not installed between the radiator and the ground terminal.

2. The wireless communication system of claim 1 wherein the dielectric material is glued to the inner side of the housing.

3. The wireless communication system of claim 1 wherein the dielectric material is locked to the inner side of the housing.

4. The wireless communication system of claim 1 wherein the dielectric material is embedded in the inner side of the housing.

5. The wireless communication system of claim 1 wherein the dielectric material is connected to the inner side of the housing in a one-unified-body structure.

6. The wireless communication system of claim 1 wherein the housing is a LCD cover.

7. The wireless communication system of claim 1 wherein the dielectric material is made of plastic.

8. The wireless communication system of claim 1 wherein the dielectric material is made of cermet.

9. The wireless communication system of claim 1 wherein the dielectric material is a glass fiber substrate.
